(19) United States
(12) Patent Application Publication
(10) Pub. No.: US 2009/0206508 A1
(43) Pub. Date: Aug. 20, 2009

(54) APPARATUS AND METHOD FOR MAKING AND BAGGING DECORATIVE GRASS

(76) Inventor: Donald E. Weder, Highland, IL (US)

Correspondence Address: DUNLAP CODDING, P.C., PO BOX 16370, OKLAHOMA CITY, OK, 73113, US

(21) Appl. No.: 12/431,043

(22) Filed: Apr. 28, 2009

Related U.S. Application Data
(63) Continuation of application No. 11/701,258, filed on Feb. 1, 2007, now abandoned.
Application No. 11/701,258 is a continuation of application No. 10/965,493, filed on Oct. 14, 2004, now abandoned.
Application No. 10/965,493 is a continuation of application No. 10/649,995, filed on Aug. 26, 2003, now abandoned.
Application No. 10/649,995 is a continuation of application No. 09/962,547, filed on Sep. 25, 2001, now abandoned.
Application No. 11/701,258 is a continuation-in-part of application No. 10/375,868, filed on Feb. 27, 2003, now abandoned.
Application No. 10/375,868 is a continuation-in-part of application No. 10/283,693, filed on Oct. 29, 2002, now Pat. No. 6,740,274.
Application No. 10/283,693 is a continuation of application No. 10/060,836, filed on Feb. 14, 2002, now abandoned.
Application No. 10/060,836 is a continuation of application No. 09/288,186, filed on Apr. 8, 1999, now abandoned.
(60) Provisional application No. 60/081,370, filed on Apr. 10, 1998.

(51) Int. Cl. B29C 37/00; B65B 1/04

(52) U.S. Cl. 264/160; 53/435

(57) ABSTRACT

An apparatus and method for producing and bagging decorative grass, comprising an extruder, a godet, a slitter, a cutter, a divider, a bagging assembly and a programmable logic controller. The extruder produces a sheet of flexible material, which is fed by the godet into the slitter, cutter and divider. The slitter slits the sheet into a web of strands of material. The cutter cuts the web of strands, producing a quantity of decorative grass, which is then divided into discrete aggregates and sent by ducts to bagging assemblies, each of which has a rotatable turret having magazines for receiving and discharging discrete aggregates, an inserter and a bag handler. A programmable logic controller coordinates the production and bagging of the decorative grass, based on the properties of the sheet and the divider, and the predetermined properties of the decorative grass.

### CROSS-REFERENCE TO RELATED APPLICATIONS

This application is a continuation of U.S. Ser. No. 11/701,258, filed Feb. 1, 2007, now abandoned; which is a continuation of U.S. Ser. No. 10/965,493, filed Oct. 14, 2004, now abandoned; which is a continuation of U.S. Ser. No. 10/649,995, filed Aug. 26, 2003, now abandoned; which is a continuation of U.S. Ser. No. 09/962,547, filed Sep. 25, 2001, now abandoned.

Said application U.S. Ser. No. 11/701,258 is also a continuation-in-part of U.S. Ser. No. 10/375,868, filed Feb. 27, 2003, now abandoned; which is a continuation-in-part of U.S. Ser. No. 10/283,693, filed Oct. 29, 2002, now U.S. Pat. No. 6,740,274, issued May 25, 2004; which is a continuation of U.S. Ser. No. 10/060,836, filed Feb. 14, 2002, now abandoned; which is a continuation of U.S. Ser. No. 09/288,186, filed Apr. 8, 1999, now abandoned; which claims benefit under 35 U.S.C. 119(e) of provisional application U.S. Ser. No. 60/081,370, filed Apr. 10, 1998.

The entire contents of each of the above-referenced patents and patent applications are expressly incorporated herein by reference.

### BACKGROUND OF INVENTION

1. Field of the Invention

The present invention relates to apparatus and methods for making filaments of decorative grass from sheet material and for uniformly dividing the filaments into a plurality of discrete aggregates of decorative grass for placement into bags or packages.

2. Description of Related Art

U.S. Pat. No. 4,292,266, issued to Weder et al., discloses a process for making decorative grass. Plastic strips are passed through a slow godet, a drawing oven and a high speed godet to enable the strips or strands to be drawn down in width and thickness without breaking. From the high speed godet, the strips or strands are chopped to a desired length and conveyed to a storage area.

The Weder '266 process does not segregate the decorative grass into uniform charges for bagging and packaging. The decorative grass is merely conveyed to a storage area.

U.S. Pat. No. 4,776,521, issued to Weder et al., discloses an apparatus and method for producing weighed charges of loosely aggregated filamentary material from compacted bales of the material. The apparatus includes a rotating drum which disintegrates bales of filamentary material into tufts of filaments. The tufts are passed to a picking chamber, where a toothed roll strips individual filaments from a supply roll formed from the tufts. The filaments are deposited on a scale until a charge of filaments is accumulated. Then air is blown across the scale to discharge the scale.

The Weder '521 apparatus does not make decorative grass from sheet material. Rather, the Weder '521 apparatus takes compacted bales of previously produced filamentary material, disintegrates the bales and weighs out charges of loose filaments.

U.S. Pat. No. 5,802,813, issued to Weder et al., discloses an apparatus and method for producing loose filaments from extruded sheet material and for immediate packaging of the filaments in uniform quantities. The apparatus includes an extruder, a godet, a slitter, a cutter and a bagging assembly.

The Weder '813 extruder provides a continuous length of sheet material to the godet, which feeds the sheet material to the slitter. The slitter makes a number of longitudinal cuts in the sheet material to define a plurality of continuous strips in the sheet of material. The strips are drawn into the cutter, where they are cut transversely to form individual filaments of decorative grass.

The individual filaments produced by Weder '813 are transferred to the bagging assembly. A programmable logic controller is provided to monitor and control the speed of the godet, the cycles of the cutter and the operation of the bagging assembly to separate the filaments into uniform charges of decorative grass.

Weder '813 does not provide for dividing the uniform charges of decorative grass into discrete aggregates of decorative grass for packaging. Neither does it provide for slitting the sheet material in a non-longitudinal manner.

### SUMMARY OF INVENTION

In one embodiment, the present invention is an apparatus and method for producing a decorative grass from extruded sheet material and for immediate packaging of the decorative grass in predetermined quantities. The apparatus includes an extruder, a godet, a slitter, a cutter, a divider and at least one bagging assembly.

The extruder provides a continuous length of sheet material to the godet, which feeds the sheet material to the slitter. The slitter makes a number of cuts in the sheet material to produce a web of strands. The web of strands is drawn into the cutter, where it is cut to produce a quantity of decorative grass. This quantity of decorative grass is then drawn into the divider, which apportions the filaments into discrete aggregates of decorative grass.

The discrete aggregates of decorative grass are transferred to the bagging assemblies. A programmable logic controller is provided to monitor and control the rate of extrusion, the speed of the godet, the cycles of the cutter and the operation of the bagging assemblies.

One object of the present invention is to provide an apparatus which produces decorative grass from sheet material and bags predetermined quantities of the decorative grass in a continuous operation.

Another object of the present invention is to provide an apparatus which requires no manual intervention from the extrusion of the sheet material through the bagging of the predetermined quantities of decorative grass.

Yet another object of the present invention is to increase efficiency and profitability by increasing the width, and therefore the overall quantity of grass continuously produced by a single machine, without sacrificing the accuracy of packaged material.

Still another object of the current invention is to more accurately package decorative grass by apportioning the grass into discrete aggregates in order to better manage the quantity of grass per charge.

Other objects, features and advantages of the present invention are apparent from the following detailed description when read in conjunction with the accompanying drawings and appended claims.

### BRIEF DESCRIPTION OF DRAWINGS

FIG. 1 is a schematic side elevational view of an apparatus for making and bagging decorative grass in accordance with the present invention.

FIG. 2 is a schematic top view of a portion of the apparatus of FIG. 1.

FIG. 3 is a flow diagram of set-up steps for a method of making and bagging decorative grass in accordance with the present invention.

FIG. 4 is a flow diagram of production steps for a method of making and bagging decorative grass in accordance with the present invention.

FIG. 5 is a partly diagrammatical top view of a bagging portion of a preferred embodiment of the apparatus. In this particular embodiment, bags are formed from sheet material.

FIG. 6 is a partly diagrammatical side view of the bagging portion shown in FIG. 5.

FIG. 7 is a partly sectional, partly diagrammatical view of one of the bagging molds shown in FIGS. 5 and 6. A sheet of material is shown before being formed into a bag.

FIG. 8 is the same view as FIG. 7 except that the sheet of material is shown after being formed into a bag.

FIG. 9 is the same view as FIG. 8 except that the bag is filled with decorative grass and is closed and sealed.

FIG. 10 is a partly sectional, partly diagrammatical view of another preferred embodiment of a bagging mold. This bagging mold forms a sheet of material into a bag shaped like an Easter bunny. The sheet of material is shown before being formed into a bag.

FIG. 11 is the same view as FIG. 10 except that the sheet of material is shown after being formed into a bag.

FIG. 12 is the same view as FIG. 11 except that the bag is filled with Easter grass and is closed and sealed.

FIG. 13 is the same view as FIG. 12 except that the mold is open to release the filled bag of Easter grass.

### DETAILED DESCRIPTION OF THE PREFERRED EMBODIMENTS

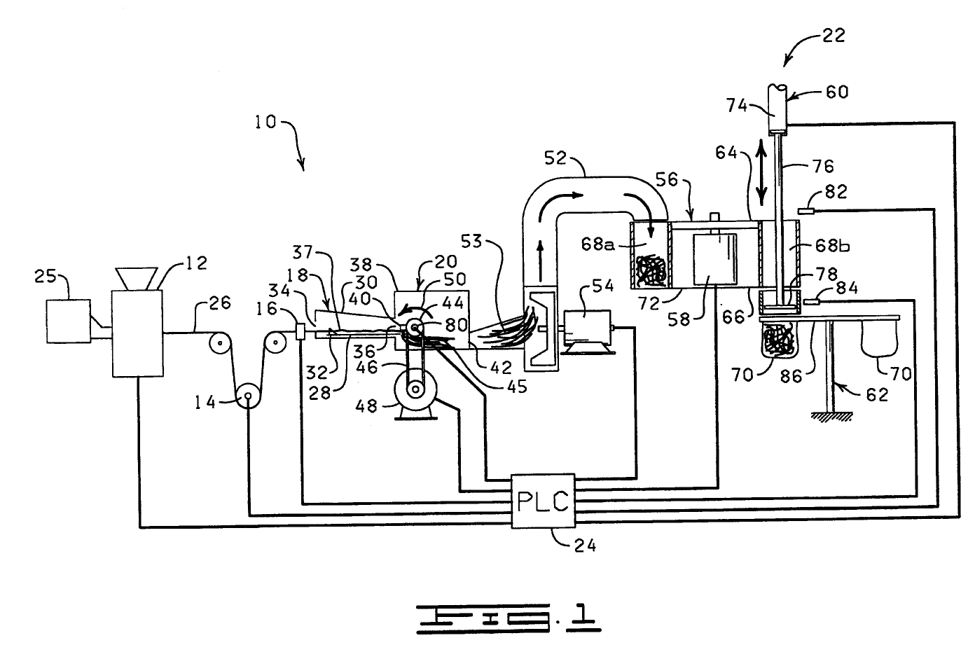

Referring to the drawings in general, and to FIG. 1 in particular, shown therein and designated by the general reference numeral 10 is an apparatus for making and bagging decorative grass, which includes an extruder 12, a godet 14, a thickness gauge 16, a slitter 18, a cutter 20, a divider 21, a plurality of bagging assemblies 22 and a programmable logic controller (PLC) 24.

The extruder 12 is any conventional machine which produces a continuous sheet of flexible material from resins, colorants, additives, anti-static agents and flame retardants. A suitable extruder is disclosed in U.S. Pat. No. 4,292,266 issued Sep. 29, 1981 to Weder et al., which is hereby incorporated by reference.

Similarly, the godet 14 may be any known device for feeding sheet material from one location to another. A typical godet includes a plurality of rollers which are rotatable to dispense a continuous web of sheet of flexible material 26. In the present invention, the godet 14 receives the sheet of flexible material 26 from the extruder 12 and feeds it into the slitter 18.

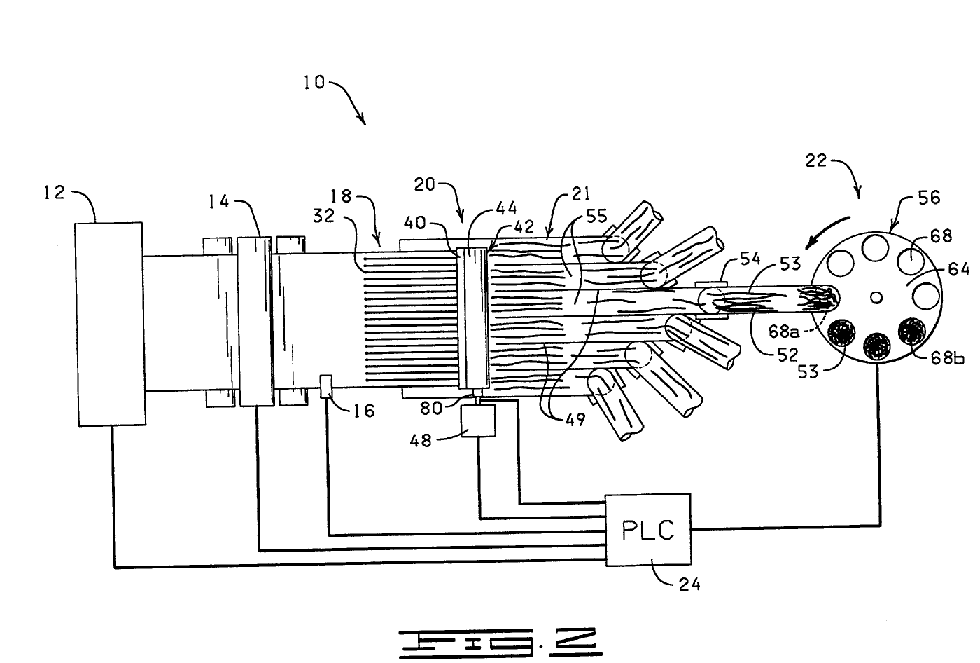

The thickness gauge 16 is typically located between the godet 14 and the slitter 18 to measure the thickness of the sheet of flexible material 26. A suitable thickness gauge 16 may be selected from several instruments which are available from Measurex, Inc. in Cupertino, Calif. As shown in FIGS. 1 and 2, the thickness gauge 16 is operatively connected to the PLC 24 to provide measurements of the thickness of the sheet of flexible material 26 to the PLC 24.

The slitter 18 includes a slitter surface 28, a plurality of slitting devices 32 and a slitter hood 30. One of the slitting devices 32 is designated by the reference numeral 32 and is generally representative of the slitting devices 32.

The slitting devices 32, which can be slitter blades in the preferred embodiment, protrude from the slitter surface 28 with cutting edges facing the incoming sheet of flexible material 26 to make a plurality of longitudinal cuts in the sheet of flexible material as the sheet of flexible material 26 travels through the slitter 18. It should be appreciated that the slitting devices 32 are spaced across the slitter surface 28 at intervals to cut the sheet of flexible material 26 into strips having the desired width for the decorative grass, thereby producing a web of strands of material 37.

While the present embodiment uses slitter blades to induce a plurality of longitudinal cuts in the sheet of flexible material 26, it should be understood that other methods for producing the web of strands 37 can also suffice. For instance, a rolling or sliding blade could induce transverse cuts of predetermined width in the sheet of flexible material 26 to produce the web of strands 37. Also, diagonal cuts could be made in the sheet of flexible material 26. Furthermore, non-linear strands could be defined in the sheet of flexible material 26.

The slitter hood 30 extends angularly over the slitter surface 28 to define a slitter entrance 34 and a slitter exit 36. The slitter entrance 34, slitter exit 36 and slitter hood 30 are sized and shaped to enhance an air flow for drawing the sheet material 26 into the slitter entrance 34 and the web of strands of material 37 out of the slitter exit 36. That is, the air space between the slitter hood 30 and the sheet of flexible material 26 gradually decreases from the slitter entrance 34 to the slitter exit 36. This construction accelerates the air flow through the slitter 18 from the slitter entrance 34 to the slitter exit 36 to keep the web of strands of material 37 substantially straight and moving smoothly through the slitter 18.

The cutter 20 includes a cutter housing 38 and a rotatable cutter blade 40. The cutter housing 38 communicates with the slitter exit 36 to receive the web of strands of material 37 into the cutter housing 38. The cutter housing 38 has a cutter exit 42 for the discharge of a quantity of decorative grass 45.

Typically, the cutter blade 40 is attached to a cutter shaft 44, which is rotatably mounted within the cutter housing 38. A belt or chain 46 and cutter motor 48 are operatively connected to the cutter shaft 44 to rotate the cutter blade 40 as indicated by a rotational arrow 50.

It should be appreciated that the cutter blade 40 extends across the width of the web of strands of material 37 to cut off the quantity of decorative grass 45 from the web of strands of material 37 with each revolution of the cutter blade 40. With a constant rate of travel of the web of strands of material 37 and a constant rate of revolution for the cutter blade 40, the quantity of decorative grass is cut from the web of strands of material 37 in predetermined quantities.

A divider 21 communicates with the cutter exit 42 to receive the quantity of decorative grass 45 from the cutter exit 42. The divider 21 includes an enclosed chute 47 having at least one and preferably a plurality of partitions 49. The partitions 49 of the divider 21 cooperate with the cutter exit 42 to apportion the quantity of decorative grass 45 into discrete aggregates of decorative grass 53. In one preferred embodiment, the partitions 49 are uniformly spaced apart so that the discrete aggregates of decorative grass 53 are formed with about uniform weight and volume. However, it should be understood that the partitions 49 may be non-uniformly spaced apart.

A plurality of ducts 52 communicate with the divider 21 and extend to the bagging assemblies 22. Each adjacently disposed pair of partitions 49 defines a channel 55. Each duct 52 communicates with one of the channels 55 to facilitate the transfer of a discrete aggregate of decorative grass 53 from the channel 55 to one of the bagging assemblies 22. A plurality of blowers 54, one for each duct 52, is provided to create an air flow for transferring filaments of decorative grass out of the cutter housing 38, through the divider 21 and the ducts 52, to the bagging assemblies 22.

Since each duct 52 and blower 54 is identical to the other ducts and blowers, the same designation number is used on each of the ducts 52 and blowers 54. Furthermore, the designation number used on the ducts 52 and blowers 54 can refer to the ducts 52 and blowers 54 either individually, or generally, as needed.

It should be appreciated that the cutter exit 42 is located at a point lower than the cutter shaft 44 and the slitter exit 36. In this manner, the quantities of decorative grass 45 cut from the slitted sheet material 37 are drawn by the blowers 54 out of the cutter housing 38 without being struck by the revolving cutter blade 40.

Furthermore, it should be understood that the number of partitions 49 is not limited to the number depicted in the drawings. The drawings are merely representational and should not be construed to limit the number of partitions 49 for a particular divider 21. Conceivably, the number of partitions 49 is limited only by the number of strands in the web of strands 37 generated by the slitter 18 and the cutter 20.

In fact, the divider need not contain partitions defining channels. Other embodiments might divide the quantities of decorative grass 45 into discrete aggregates of decorative grass 53 using a series of openings or a plurality of chutes down which each discrete aggregate of decorative grass 53 would fall. This process might be aided by a blower or a vacuum pump, thereby accelerating the process.

Additionally, using a blower or vacuum pump, the divider 21 could separate the quantities of decorative grass 45 into discrete aggregates of decorative grass 53 utilizing a plurality of heads set over the quantities of decorative grass 45. A vacuum pump could draw the quantity of decorative grass 45 into the plurality of heads, thereby separating it into discrete aggregates of decorative grass 53. The same effect could be realized through the use of a blower, instead of a vacuum.

The alternative methods of dividing the decorative grass may be useful for the separation of decorative grass with transverse or diagonally disposed strands, since partitions may not separate quantities of decorative grass 45 with strands not cut longitudinally.

The bagging assemblies 22 each include a rotatable magazine turret 56, an index motor 58 for driving the rotation of the magazine turret 56, an inserter 60 and a bag handler 62. A suitable bagging assembly 22 is available from Prodo-Pak in Garfield, N.J.

Since each of the bagging assemblies 22 is identical to the other bagging assemblies 22, all bagging assemblies 22 are referenced, either individually or collectively, using the same designation number “22”. Also, since each of the bagging assemblies 22 is identical, only one bagging assembly 22 will be described in detail.

As best shown in FIG. 2, the magazine turret 56 has a plurality of magazines extending from top 64 to bottom 66 through the magazine turret 56. One of the magazines is designated by reference numeral 68 and is generally representative of the magazines of the magazine turret 56.

Another one of the magazines, designated by reference character 68a, is in a fill position. Until rotated out of the fill position, the magazine 68a communicates with the duct 52 to receive discrete aggregates of decorative grass.

Yet another one of the magazines, designated by reference character 68b, is in a discharge position. The magazine 68b is located over a bag 70 for deposit of the filaments of decorative grass of the magazine 68b into the bag 70.

A stationary plate 72 is located at the bottom 66 of the magazine turret 56 to cover the lower end of the magazines 68 which are waiting to be discharged into bags 70. Thus, the stationary plate 72 keeps the filaments from falling out of the magazines 68 during filling, and after filling, until the discharge position is reached. Alternatively, the stationary plate 72 may be sized and shaped to cover the entire bottom 66 of the magazine turret 56 except for the discharge position.

The index motor 58 is adapted to rotate the magazine turret 56 to locate the magazines 68, one at a time, into the fill position. The magazine turret 56 is rotated by the index motor 58 such that the magazines 68 advance from position to position in step-wise fashion.

As illustrated by FIG. 2, the magazine turret 56 typically has eight magazines 68. While one of the magazines 68a is being filled with decorative grass, another of the magazines 68b is in the discharge position, three of the magazines are already filled and await rotation into the discharge position, and three of the magazines are empty and await rotation into the fill position. Although the magazine turret 56 typically has eight magazines 68, it should be appreciated that the magazine turret 56 may have any number of magazines consistent with the scope and purpose of the present invention.

The inserter 60 comprises a pneumatic cylinder 74 having a piston 76 which is extendable through the discharge magazines 68b. A push plate 78 is attached to the end of the piston 76 to force decorative grass out of the discharge magazine 68b and into the bag 70 as the piston 76 is extended. Of course, the piston 76 and push plate 78 must be retractable from the discharge magazine 68b in order for the magazine turret 56 to rotate when required.

It should be appreciated that a hydraulic or electric cylinder or any like device may be employed in place of the pneumatic cylinder 74. In an alternate embodiment, a blast of air, gases or gases containing an anti-static agent may be used to force the decorative grass from the magazines 68 instead of a cylinder and piston.

Furthermore, it should be understood that more than one duct 52 may go to each turret 56. In fact, all the ducts 52 may go to a single turret 56. Under such a system, the usage of the magazines 68 relative to the ducts 52 could vary. For instance, the turret 56 could rotate the magazines 68 at each cut. Each magazine 68 would be indexed so that a different duct 52 would deposit its load at each cut, then indexed again. In this way, the predetermined number of discrete aggregates of decorative grass 53 per charge of decorative grass would be equal to the number of ducts 52 per turret 56.

Alternatively, the number of ducts 52 could equal half the number of magazines 68 in a turret 56. Under this method, the positions of the turret 56 would alternate between magazine 68 loading positions and magazine 68 emptying positions, with the turret 56 being indexed after a predetermined number of cuts of the rotatable blade.

Many other possible combinations of ducts 52 and turrets 56 along with the methods of interaction between them are conceivable within the scope of the current invention. The embodiments listed above are to be construed as examples of the current invention.

The PLC 24 is operatively connected to the various components of the apparatus 10. In particular, the PLC 24 is connected to the extruder 12 and the godet 14 to monitor and control the rate at which the sheet of flexible material 26 is fed to the slitter 18 and cutter 20. Further, the PLC 24 is programmed to receive as input the width, thickness and density of the sheet of flexible material 26 produced by the extruder 12.

In addition, the PLC 24 is operatively connected to the cutter motor 48 to monitor and control the speed of the cutter motor 48 and, in turn, the r.p.m. s of the cutter blade 40. Further, the PLC 24 may be connected to any conventional mechanical or electronic device 80 for sensing and counting the number of revolutions of the cutter blade 40. Such devices are well known in the art and any one of a number of suitable components may be used.

As shown in FIGS. 1 and 2, the PLC 24 may be operatively connected to the air blowers 54, the index motors 58 and the inserters 60. Conventional devices and connections are provided to allow the PLC 24 to monitor and control the air flow rates produced by the air blowers 54. The PLC 24 is connected to the index motors 58 to actuate the index motors 58 for rotating the magazine turrets 56 to advance their respective magazines 68.

The PLC 24 is connected to the inserters 60 to actuate the extension and retraction of the pistons 76 and push plates 78. A plurality of upper limit switches 82, one for each piston, is provided and connected to the PLC 24 to indicate to the PLC 24 when the respective pistons 76 and push plates 78 are fully retracted from the discharge magazines 68b of the magazine turrets 56. Further, a plurality of lower limit switches 84, one for each piston, is provided and connected to the PLC 24 to indicate to the PLC 24 when the respective push plates 78 are fully extended through the discharge magazines 68b of the magazine turrets 56.

The bag handler 62 for each bagging assembly 22 is provided for disposing an open bag beneath the discharge magazine 68b. The bag handler 62 may comprise two bag racks 86 which are alternately rotated under the discharge magazine 68b. In this manner, one bag rack 86 supports a bag being filled with decorative grass while a filled bag is removed from the other bag rack 86 and replaced with an empty bag. It should be appreciated that the bag handler 62 may be operated manually or may be a part of a conventional automated bag handling system (not shown).

Furthermore, it should be appreciated that the PLC 24 may control the respective bagging intervals between the indexing of the turrets 56 by timing. Alternatively, the control of the bagging intervals may be effected by referencing the indexing of the turrets 56 to a predetermined number of cuts of the cutter 20.

### Operation

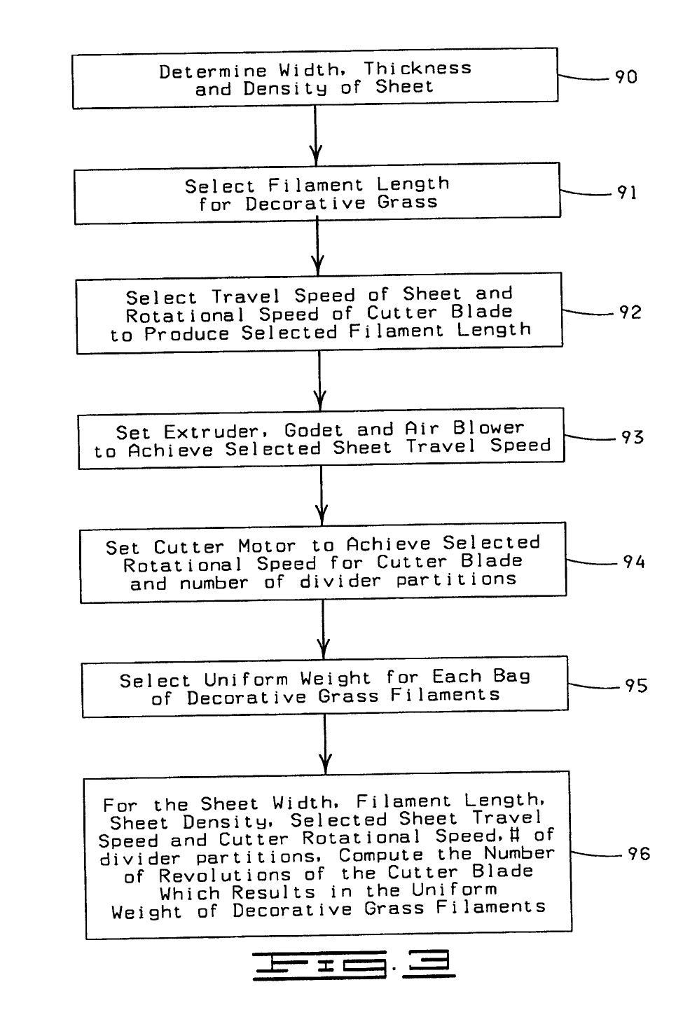

With reference to FIG. 3, shown therein are the steps executed by the PLC 24 to set up the apparatus 10 for operation. First, the extruder 12 is set to produce sheet material 26 having a known width and density. The sheet width and sheet density are input to the PLC 24. This may be done manually or by any conventional connection between the extruder 12 and the PLC 24.

As the sheet material 26 is advanced by the godet 14, the thickness gauge 16 measures the thickness of the sheet material 26. The sheet thickness is automatically communicated from the thickness gauge 16 to the PLC 24 (FIG. 3, Block 90). Thus, the sheet width, sheet density and sheet thickness are known quantities to the PLC 24.

Then, a length for the filaments comprising the decorative grass product is selected (Block 91). A travel speed for the sheet material 26 and a rotational speed for the cutter blade 40 are selected to produce filaments of decorative grass having the selected filament length (Block 92).

It should be appreciated that the width of the filaments is determined by the spacing of the slitting devices 32. It may be desirable that the slitting devices 32 be removably mounted to the slitter surface 28. In this way, slitting devices 32 with different spacings may be mounted to the slitter surface 28 in order to produce filaments in a wide variety of widths.

The production speed of the extruder 12, godet 14 and the air blower 54 are adjusted by the logic of the PLC 24 to achieve the selected travel speed (Block 93) of the sheet of flexible material 26 through the slitter 18 and cutter 20. Further, the cutter motor 48 is set such that the cutter blade 40 has the rotational speed to produce filaments having the selected filament length for the selected travel speed of the sheet of flexible material 26. Also, the number of partitions 49 of the divider 21 and/or the relative spacing of the partitions 49 is selected (Block 94).

Utilizing the selected production speeds, sheet width, number or spacing of the partitions 49, sheet density, and sheet thickness measured by the thickness gauge 16, the program logic of the PLC 24 computes how many revolutions of the cutter blade 40 are required in order to result in the desired uniform weight (Block 95) of grass to be placed in each bag (Block 96). This computation of cutter blade 40 revolutions is used by the PLC 24 to control the operation of the bagging assembly 22.

As illustrated by FIG. 4, the production and bagging of decorative grass is begun by zeroing the count of cutter blade 40 revolutions and rotating an empty magazine 68 into the fill position (Block 100). Then the sheet of flexible material 26 is slit, cut, divided and blown into the magazines 68a until the computed number of revolutions of the cutter blade 40 is reached (Block 101).

When the computed number of revolutions of the cutter blade 40 is reached, the PLC 24 causes the corresponding index motors 58 to rotate the corresponding magazine turrets 56 such that the next magazine 68 of that magazine turrets 56 is situated in the fill position (Block 102). The count of cutter blade 40 revolutions is reset to zero. As soon as the next magazine 68 is advanced into the fill position, it begins to receive decorative grass from the duct 52.

Rotation of the corresponding magazine turrets 56 also moves filled magazines 68 into the discharge position (Block 102). As soon as the rotation of the magazine turret 56 is complete, the PLC 24 actuates the inserters 60 to force the contents of the discharge magazine 68b into the bag 70 disposed below or adjacent to the discharge magazine 68b (Blocks 103 and 104).

Limit switches 82 and 84 for the respective magazine turrets 56 sense when the push plates 78 of the inserters 60 are fully extended through the discharge magazine 68b and fully withdrawn from the discharge magazines 68b. The PLC 24 should also have logic to prevent rotation of the magazine turrets 56 unless the push plates 78 are completely withdrawn from the discharge magazines 68b.

After being filled, the bags 70 are moved from the discharge magazines 68b and respective empty bags are placed into position for receiving grass during the next discharge cycle (Block 105). Typically, the filled bags are sealed, labeled and packaged for shipment to points of distribution and sale.

As soon as each discharge cycle is initiated, the PLC 24 zeroes the counter for the revolutions of the cutter blade 40 and the fill-and-discharge procedure is repeated. By utilizing the calculations of the PLC 24 and the counter device 80, scales for weighing out uniform quantities of decorative grass are eliminated.

By obviating the need for scales, the present invention simplifies the task of uniformly bagging decorative grass. Further, the present invention allows the production and bagging of decorative grass in a single, continuous operation.

The present invention may be modified in a wide variety of ways. For example, the thickness of the sheet of flexible material 26 from the extruder 12 may be assumed to be substantially constant. In such a case, the thickness gauge 16 may be replaced by any known device for measuring the length of sheet material passing by the device. The PLC 24 may control the components of the system according to the lengths measured by the device rather than by the density and travel speed of the sheet of flexible material 26 and the revolutions of the cutter blade 40.

As another example, the thickness and travel speed of the sheet of flexible material 26 may be assumed to be substantially constant. In this instance, any conventional timing device may be used in place of the thickness gauge 16 and the revolution counter device 80. The PLC 24 may control the components of the system according to time intervals corresponding to the density, dimensions and travel speed of the sheet of flexible material 26.

### Bag Formation

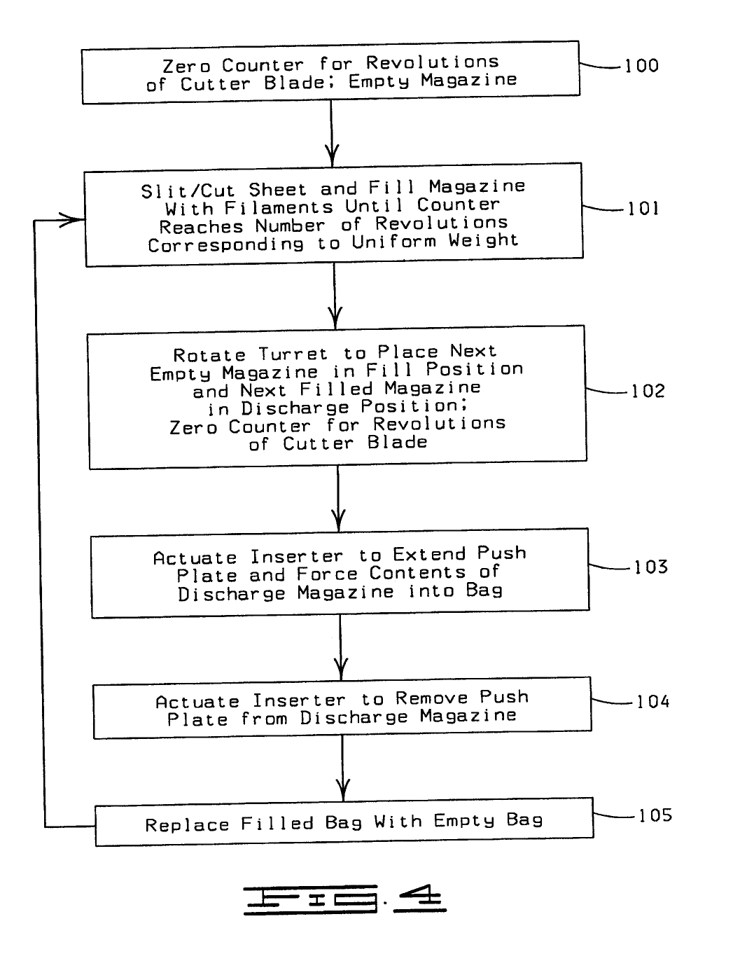

With reference to FIGS. 5 through 9, shown therein and designated by reference character 90 is a preferred embodiment of a bagging system which forms bags from sheet material. The bagging system 90 comprises a mold turret 92, an a.c. power source 94, a vacuum source 96, a motor 98, a heat source 100, a roll of sheet material 102 and a sheet cutter 104. As shown in FIG. 5, the PLC 24 is connected to the bagging system 90 to control and coordinate its functions according to the sequence of operations disclosed herein below.

The mold turret 92 includes a plurality of bagging molds 106 and is rotatable by the motor 98. Further, the mold turret 92 is arranged such that the bagging molds 106 are successively positioned at the discharge end of the discharge magazine 68b position as the mold turret 92 is rotated.

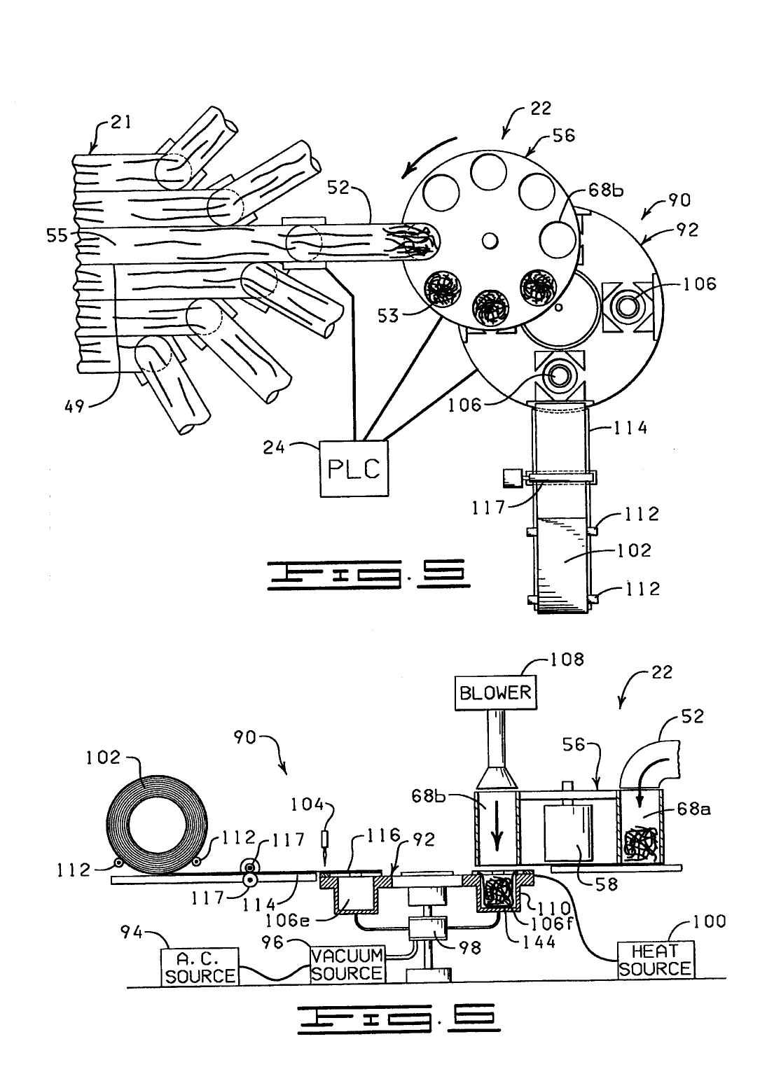

As shown in FIG. 6, a blower 108 may be provided to urge the decorative grass from the discharge magazine 68b into a receiving bag 110. However, the bagging system 90 may have the inserter 60 instead of the blower 108 (FIG. 1) for urging the grass into the bag 110.

A pair of rollers 112 are provided to support the roll 102 of sheet material over a substantially flat feed surface 114. The rollers 112 are adapted to successively feed end portions 116 of the sheet material to a position over an empty bag mold 106e.

A pair of feed rollers 117 are rotatably mounted to feed sheet material there between along the sheet feed surface 114. The sheet cutter 104 is mounted over the sheet material for successively cutting end portions 116 from the continuous length of sheet material.

With reference to FIGS. 7 through 9, shown therein is one of the bagging molds 106 in detail. Typically, each bagging mold 106 is generally cylindrical. However, it should be appreciated that the bagging molds 106 may be constructed in a wide variety of shapes.

Each bagging mold 106 has a first end 118, a second end 120 and a mold opening 122 extending from the first end 118 toward the second end 120. Around the first end 118, a substantially flat holding surface 124 is provided to support a sheet 126 cut from the end portion 116 of the roll 102 of sheet material.

The holding surface 124 has a plurality of vacuum holes 128 for maintaining the cut sheet 126 in place by means of a vacuum. Further, a lower portion of the side walls and all of the bottom walls of each bagging mold 106 have an inner wall 130 and an outer wall 132. The inner walls 130 and outer walls 132 are spaced apart to define a vacuum annulus 134.

The inner wall 130 is provided with a plurality of inner vacuum holes which communicate with the mold opening 122 and the vacuum annulus 134. Several of the inner vacuum holes are designated by reference numeral 136 and are generally representative of the interior vacuum holes.

Vacuum lines 138 are provided to connect the vacuum holes 128 and 136 to the vacuum source 96. A vacuum valve 140 is located in each vacuum line 138 to control the amount of vacuum applied to the vacuum holes 128 and 136.

In operation, the end portion 116 of the sheet material 102 is fed over the empty bagging mold 106e. Vacuum is applied to the vacuum holes 128 in the holding surface 124 of the empty bagging mold 106e. Then the sheet cutter 104 is actuated to cut the end portion 116 from the sheet material 102 (FIGS. 6 and 7).

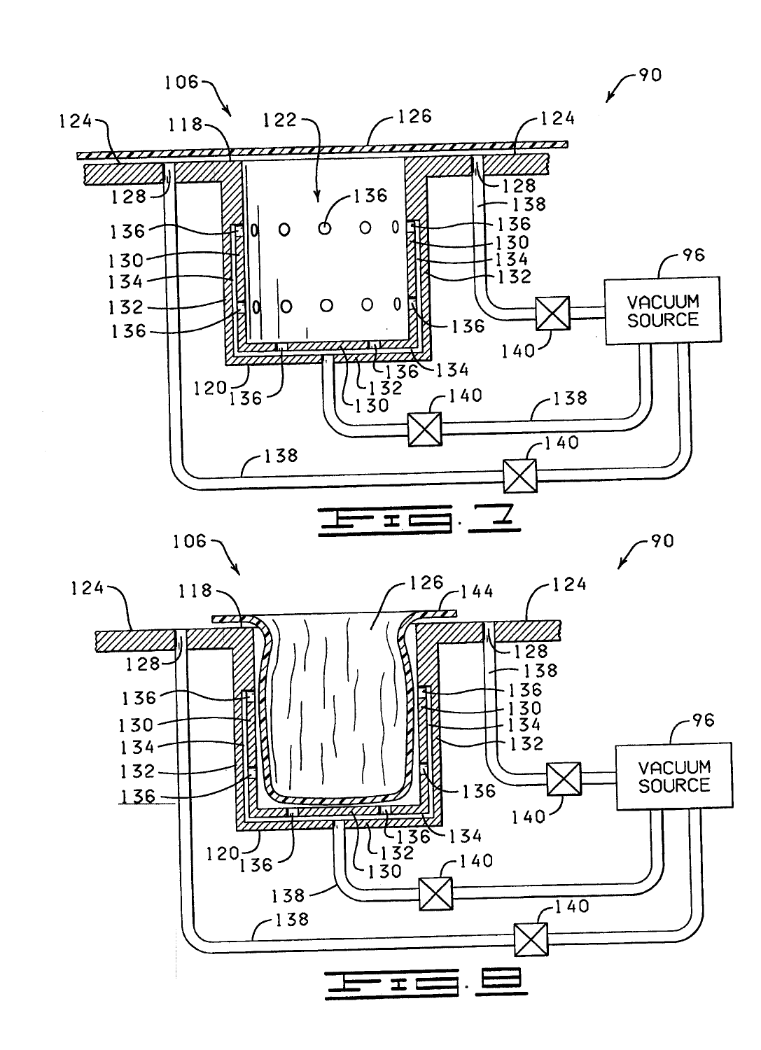

The vacuum on the vacuum holes 128 in the holding surface 124 is reduced or cut off as the vacuum on the inner vacuum holes 136 is increased or turned on. This action draws the end portion 116, which is now a cut sheet 126 of material into the mold opening 122 of the bagging mold 106e to form the bag 110 (FIG. 8).

The cutting and bag forming may be performed at the same rotational position of the mold turret 92. Alternatively, the cutting may be done at one position and the bag forming may take place at any other rotational position before the bag filling position.

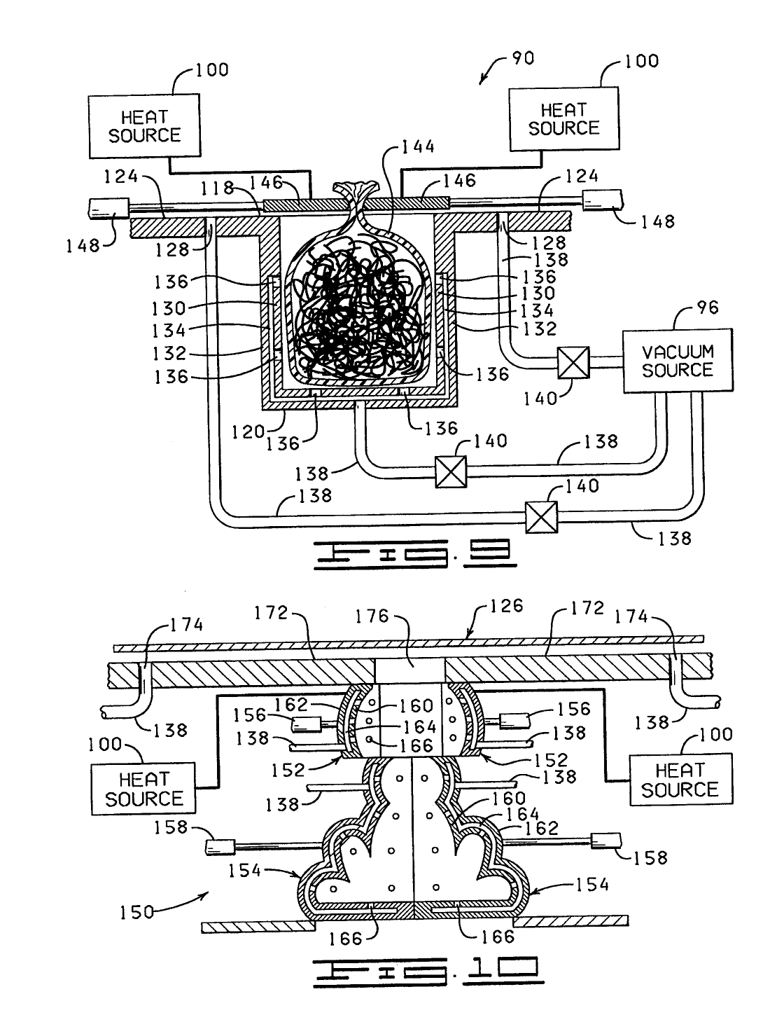

The mold turret 92 is rotated to place the formed, empty bag 110 in the bag filling position. The blower 108 produces an air flow to force the decorative grass from the magazine of the magazine turret 56 and into the bag 110 in bagging mold 106f (FIGS. 6 and 9).

The filled bag 110 may then be closed and sealed in any conventional manner, such as with a twist tie, closure tag, adhesive strip or the like. As shown in FIG. 9, a plurality of closure blocks 146 moveable by closure cylinders 148 may be provided to close the filled bag 110.

Alternatively, the sheet of material may comprise any conventional adhesive or cohesive substance to seal the bag closed upon contact with itself. In another preferred embodiment, the sheet material may comprise any conventional heat-sealable substance and the heat source 100 may be connected to each closure block 146 to effect heat-sealed closure of each bag 110 (FIG. 9).

### Embodiment of FIGS. 10 through 13

Referring to FIGS. 10 through 13, shown therein and designated by reference numeral 150 is a preferred embodiment of a bunny mold. The bunny mold 150 is constructed to form the cut sheet 126 of material into a bag in the shape of an Easter bunny.

The bunny mold 150 is a split mold having two ear halves 152 and two body halves 154. An ear cylinder 156 is connected to each ear half 152 to move the ear halves 152 between an open and a closed position. Similarly, a body cylinder 158 is attached to each body half 154 to move the body halves 154 between an open and a closed position.

Each one of the ear halves 152 and the body halves 154 have inner walls 160 and outer walls 162 separated by a vacuum annulus 164. The inner walls have a plurality of vacuum holes 166 communicating with the vacuum annulus 164. Vacuum lines 168 and vacuum valves 170 are provided to connect the vacuum annulus 164 of each ear half 152 and each body half 154 to the vacuum source 96.

A substantially flat holding surface 172 with a plurality of vacuum holes 174 is provided above the ear halves 152 to support the cut sheet 126 of material. The holding surface 172 has an opening 176 there through to allow the cut sheet 126 of material to be drawn by vacuum into the interior of the bunny mold 150.

In operation, the ear halves 152 are moved to the open position and the body halves 154 are moved to the closed position. At this time, the cut sheet 126 of material is held by vacuum through the vacuum holes 166 of the holding surface 172 (FIG. 10). For clarity of illustration, the vacuum source 96, the vacuum valves 170 and portions of the vacuum lines 168 are not shown in FIGS. 10 through 13.

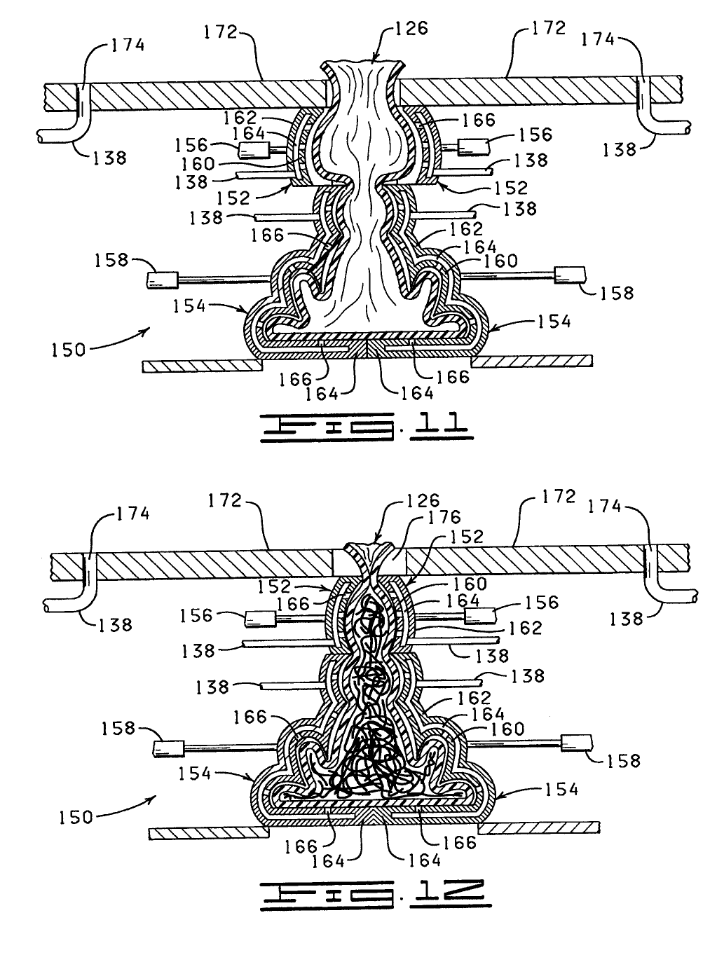

Next, the vacuum on the vacuum holes 174 in the holding surface 172 is reduced or cut off as the vacuum on the inner vacuum holes 166 is increased or turned on. This action draws the cut sheet 126 of material through the opening 176 of the holding surface 172 and into the bunny mold 150 (FIG. 11). For clarity of illustration, the heat source 100, the vacuum source 96, the vacuum valves 170 and portions of the vacuum lines are not shown in FIGS. 11 through 13. It should be appreciated that the cut sheet 126 of material should be sufficiently flexible to be drawn against the inner walls 160 within the bunny mold 150 by the vacuum.

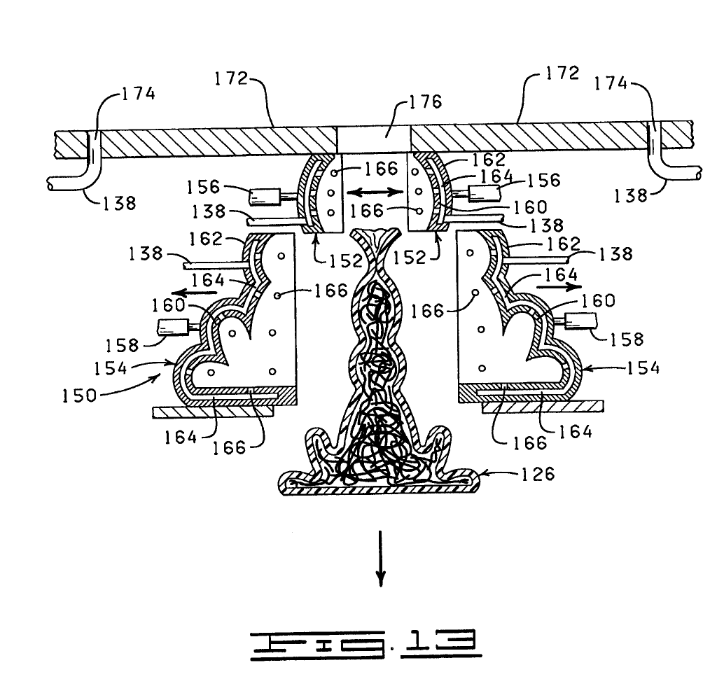

After the bag is filled with decorative grass, the ear halves 152 are closed to form the ears and to seal the bag (FIG. 12). The cut sheet 126 of material may comprise any conventional adhesive or cohesive substance, in which case the bag seals shut upon contact with itself.

In another preferred embodiment, the cut sheet 126 of material comprises a heat-sealable substance. In this case, heat is applied by heat sources 100 to an upper portion of each one of the ear halves 152 to effect a heat-sealed closure of the bag (FIGS. 10 and 12).

Once the bag is sealed, both the ear halves 152 and the body halves 154 are opened to release the formed, filled and sealed bag (FIG. 13).

It should be appreciated that a wide variety of molds may be utilized in a manner similar to that disclosed herein. For example, molds for forming bags in the shape of chicks, ducks, any other animals or any inanimate object may be constructed within the scope and purpose of the present invention.

### Low-Density Decorative Grass

Referring back to FIG. 1, the foam injector 25 is connected to the extruder 12 to inject a foaming agent or blowing agent into the material being extruded into sheet material. The foaming agent is provided to produce a sheet of flexible material 26 having a low density.

The foaming agent may be air, nitrogen or any suitable gaseous mixture or compound. In this case, the foaming agent is injected into the extrusion mixture under pressure to create tiny gas bubbles in the extruded material.

In another preferred embodiment, the foaming agent is a compound or substance which is activated by heat to evolve a gas such as carbon dioxide. Examples of this type of foaming agent are baking powder, sodium bicarbonate, ammonium carbonate, pentane and hydrazine and related compounds.

In using one of the heat-activated foaming agents, pellets for the extrusion material, such as polystyrene pellets, and the foaming agent are introduced into the extruder 12. Heat is used to melt the pellets and with the heat the foaming agent evolves a gas into the material to reduce the density of the extruded material.

Changes may be made in the combinations, operations and arrangements of the various parts and elements described herein without departing from the spirit and scope of the invention as defined in the following claims.

What is claimed is:

1. A method for making decorative grass from a sheet of material, the method comprising the steps of:
providing a sheet of material having a sheet width, a sheet thickness and a sheet density;
selecting a predetermined length and width for decorative grass, and at least one predetermined weight or at least one predetermined volume for charges of decorative grass to be packaged;
selecting the number of discrete aggregates of decorative grass produced per cut and the weight or volume of each discrete aggregate of decorative grass such that the sum of the weight or sum of the volume of one or more discrete aggregates of decorative grass substantially totals the predetermined weight or predetermined volume of a charge of decorative grass;
slitting the sheet of material to produce a web of strands of material;
cutting across at least one of the sheet of material and the web of strands of material at a controlled rate corresponding to the predetermined length of the decorative grass to make a quantity of decorative grass;
dividing, at each cut, the quantity of decorative grass into the predetermined number of discrete aggregates of decorative grass per cut; and
placing at least one controlled charge of decorative grass into a package.

2. A method for making decorative grass from a sheet of material, the method comprising the steps of:
providing a sheet of material having a sheet width, a sheet thickness and a sheet density;
selecting a predetermined length and width for decorative grass, and at least one predetermined weight or at least one predetermined volume for charges of decorative grass to be packaged;
selecting the number of discrete aggregates of decorative grass produced per cut and the weight or volume of each discrete aggregate of decorative grass such that the sum of the weight or sum of the volume of one or more discrete aggregates of decorative grass substantially totals the predetermined weight or predetermined volume of a charge of decorative grass;
cutting across at least one of the sheet of material and the web of strands of material at a controlled rate corresponding to the predetermined width of the decorative grass to make a quantity of decorative grass;
dividing, at each cut, the quantity of decorative grass into the predetermined number of discrete aggregates of decorative grass per cut; and
placing at least one controlled charge of decorative grass into a package.

3. A method for producing and packaging filaments of material, the method comprising:
providing a sheet of flexible material having a thickness, a width, a density and a controlled travel speed;
slitting the sheet of flexible material to produce a web of strands of material having a predetermined width;
cutting at least one of the sheet of flexible material and the web of strands of material using a cutter having a controlled rate so that a quantity of filaments of material is cut therefrom;
dividing at a predetermined rate the quantity of decorative grass into a plurality of discrete aggregates of decorative grass using a divider having at least one partition;
positioning a package to receive at least one discrete aggregate of decorative grass;
transferring at least one discrete aggregate of decorative grass into the package, the weight and volume of the discrete aggregate of decorative grass being based on the controlled rate of the cutter and on the number of partitions in the divider; and
removing the package containing the discrete aggregates of decorative grass.

4. A method for producing and packaging decorative grass, the method comprising the steps of:
producing at a predetermined rate a quantity of decorative grass comprising elongate and flexible filaments of material;
dividing at a predetermined rate the quantity of decorative grass into a plurality of discrete aggregates of decorative grass using a divider having at least one partition;
positioning a package to receive at least one discrete aggregate of decorative grass;
transferring at least one discrete aggregate of decorative grass into the package based on the predetermined rate at which the decorative grass is being produced and on the number of partitions in the divider; and
removing the package containing the decorative grass.

5. The method of claim 4 further comprising the steps of:
providing a sheet of material having a thickness, a width, a density and a predetermined travel speed;
slitting the sheet of material to produce a web of strands of material having a predetermined width; and
cutting the strands of material into quantities of decorative grass.
